(19) United States
(12) Patent Application Publication
(10) Pub. No.: US 2004/0016195 A1
(43) Pub. Date: Jan. 29, 2004

(54) Foamed glass article for use as thermal energy control media

(76) Inventor: John Paul Archuleta, Santa Fe, NM (US)

Correspondence Address: John Paul Archuleta, c/o Aaron Bartels, 3600 Cerrillos, #107, Santa Fe, NM, 87507-2613, US

(21) Appl. No.: 10/205,253

(22) Filed: Jul. 24, 2002

(51) Int. Cl. A01G 9/00; E04B 1/74; E04B 2/00; E04B 5/00; E04B 9/00

(52) U.S. Cl. 52/506.01; 52/404.1; 47/17

(57) ABSTRACT

Methods, systems and apparatuses for controlling thermal energy utilizing a foamed glass article are described. A foamed glass article can be provided as a thermal energy control medium. The foamed glass article (i.e., thermal energy control medium) can be integrated into an object, such as walls of a building, walls of a fireplace, a ceiling, floor, door and/or lid of a container and so forth, to assist in maintaining thermal energy within the object, including an environment associated with the object.

### TECHNICAL FIELD

The present invention is generally related to heating and cooling methods and systems. The present invention is also related to solar energy heating and cooling methods and systems. The present invention is also related to construction materials utilized in constructing buildings and homes. The present invention is additionally related to thermal energy control media.

### BACKGROUND OF THE INVENTION

The present inventor has recognized that a continuing need exists for improved heating and/or cooling systems, methods and apparatuses. The present inventor has conducted tests on the use of foamed glass articles for use as a thermal energy control medium. In particular, the present inventor has studied a particular type of foamed glass article. Such foamed glass articles have traditionally been utilized for preparing surfaces because of their recognized abrasive nature. To date, however, such foamed glass articles have not been utilized as a thermal energy control medium. This need has not been recognized by those skilled in the art, because of the heretofore primary focus on surface preparation techniques.

A particular type of foamed glass article is disclosed in U.S. Pat. No. 5,972,817, “Foamed Glass Article for Preparing Surfaces, Use Therefor, and Method of Making Same” to Haines et al., which issued on Oct. 26, 1999. A similar foamed glass article is disclosed in U.S. Pat No. 5,821,184, “Foamed Glass Article for Preparing Surfaces, Use Therefore and Method of Making Same” to Haines et al., which issued on Oct. 13, 1998. Another type of foamed glass article is disclosed in U.S. Pat. No. 5,928,773, “Foamed Glass Articles and Methods of Making Same and Methods of Controlling the PH of Same Within Specific Limits” to James C. Andersen, which issued on Jul. 27, 1999. Note that U.S. Pat. No. 5,972,817, U.S. Pat. No. 5,821,184, and U.S. Pat. No. 5,928,773 are incorporated herein by reference.

The foamed glass article disclosed in U.S. Pat. No. 5,972,817 and U.S. Pat. No. 5,821,184 (the “Haines patents”) is formed in the shape of a block, disk or similar product that can be utilized to prepare surfaces by sanding, rubbing and scraping the same in order to clean, abrade, polish and so forth. The Haines patents describe a surface preparing means in the form of a foamed glass having any desired specific shape, with the foamed glass article being derived from a starting mixture that comprises glass and generally 0.10-20.0% by weight of at least one non-carbon/sulfate based foaming agent. The Haines patents describe methods of making foamed glass specifically as a surface preparing means, including the steps of providing powdered or ground glass, mixing at least one non-carbon/sulfate based foaming agent with the powdered glass to form a mixture, placing the mixture on a surface, such as a belt, plate, or in a mold, heating the mixture on the belt or in the mold so that the mixture sinters and subsequently foams, and annealing the foamed mixture by cooling the same to room temperature to form a foamed glass product.

Glass used in the methods described by Haines can be provided as virgin glass or waste glass. The term “waste glass” generally refers to any waste glass that is waste or scrap, either from a pre-consumer manufacturing operation, such as window plate manufacturing, glass bottle manufacturing, light bulb manufacturing, glass bead manufacturing, and the like, or post-consumer waste glass, such as bottles collected by a public or private recycling operation. Such recycled or otherwise recovered glass can include soda lime glass, borosilicate glass, alumino silicate glass, and recycled foamed glass. The glass can be utilized in powdered or otherwise pulverulent form and has an average particle size distribution that ranges from 1-500 μ. Although, as indicated, any glass can be used; but to ensure consistency of the glass, clean glass or even virgin glass is preferred.

Although the starting mixture is intended to cover a range of powdered or ground glass and 0.10-20% by weight of foaming agent, it is presently contemplated that a preferred range will be 0.5-5.0% by weight of foaming agent. In addition, pursuant to a preferred heating step, the mixture of powdered glass and foaming agent is first heated to a sintering temperature and subsequently the temperature is increased to effect foaming. For example, the mixture can first be heated to a temperature of about 1250° F. with this temperature being maintained for a given period of time, such as for one hour; the temperature can then be increased to a range of 1274-1700° F. to effect foaming. Annealing of the foamed mixture can either comprise a gradual cooling to room temperature, or, pursuant to a preferred embodiment, can comprise the steps of first rapidly cooling the foamed mixture to a temperature below a foaming temperature, and then slowly cooling the foamed mixture to room temperature. Any glassy skin or crust that is formed on the resulting product can be removed, at least from abrasive surfaces, such as by cutting or planing using any suitable means.

The starting mixture of powdered glass and foaming agent can comprise 69.9-99.9% by weight glass and 0.10-20% by weight foaming agent including mixtures of two or more foaming agents; in addition, 0-30.0% by weight of additional abrasive material can be added to the mixture prior to placing such a mixture in a mold. It should be noted that although the mixture can be placed on a belt or plate, it is presently common to use molds. A single larger mold or a plurality of smaller discrete molds can be provided. The smaller molds can actually have a geometry that is substantially the same as the desired final geometry of the foamed glass articles. If a larger mold is used, the product produced can be cut to the desired size and shape. In addition, placing one or more mounds thereof in the mold or molds, possibly forming one or more rows of such mounds, can place the mixture in the mold or molds. Although calcium carbonate appears to be a particularly expedient foaming agent, a large variety of non-carbon/sulfate based foaming agents can be used. Examples of such foaming agents include, but are not limited to magnesium carbonate, sodium carbonate, strontium carbonate, lithium carbonate, barium carbonate, sugar, urea, water, and mixtures thereof.

Based on the foregoing, the present inventor has concluded that foamed glass articles can be utilized to fulfill a need that exists for heating and cooling. The present inventor believes that the foamed glass articles described in greater detail herein have particularly useful applications as a thermal energy control media, such as insulation, head conduction, and cooling, and fireproof applications because of the physical properties and material consistency if foamed glass articles.

### BRIEF SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

It is therefore one aspect of the present invention to provide a foamed glass article for us as a thermal energy control medium.

It is another aspect of the present invention to provide a foamed glass article for use as a thermal energy control medium in heating and/or cooling a building.

It is still another aspect of the present invention to provide a foamed glass article for use as a thermal energy control medium in a container (e.g., a portable cooler, kitchen appliance, etc.).

It is yet another aspect of the present invention to provide a foamed glass article for us as a thermal energy control medium in a fireplace.

It is also an aspect of the present invention to provide a foamed glass article for use as a thermal energy control medium in a fireproof container.

It is a further aspect of the present invention to provide a foamed glass article as a thermal energy control medium for use in the germination of seedlings in an agricultural environment.

The above and other aspects of the invention can be achieved as will now described. Systems, methods and apparatuses are disclosed herein for controlling thermal energy utilizing a foamed glass article. A foamed glass article can be provided as a thermal energy control medium. The foamed glass article can be integrated into an object (e.g., system or apparatus) such as: the walls, ceiling and floors of a building; the interior and/or exterior walls of a fireplace; as the insulation media used in a container, such as a cooler, kitchen appliance or safe; and so forth, to assist in maintaining thermal energy (hot, warm, cool, cold) within the object, including an environment associated with the object.

The foamed glass article can be configured in the shape of a block, sheet, disk, brick, a plurality of cubes, and so forth. If the object is a building, one or more walls, including a roof, ceiling or floor, associated with the building can be adapted to utilize a foamed glass article within its construction to provide passive heating and cooling for the building environment. If the object comprises a container, such as an recreational cooler or portable medical/laboratory cooling mechanism, it can be configured such that the walls (including the lid or door, and bottom) of the container includes a gap within which the foamed glass article (i.e., thermal energy control medium) is located, thereby forming a thermal barrier to assist in preventing thermal energy (heat, warmth, cool) from escaping from the controlled environment of the container.

Additionally, the thermal control medium can be soaked with water or another liquid and then frozen. Once the foamed glass article is frozen, the foamed glass article can be placed within a container (e.g., a cooler) to assist in cooling. The foamed glass article can be reused after it thaws. The object can also be configured a fireplace which is constructed from the foamed glass article (i.e., thermal energy control medium) to promotes the retention and control of heat thereof.

The object can also be a container, such as a safe, which is constructed from the foamed glass article to thereby configure the container as a fireproof container. Additionally, the object can be arranged as an agricultural environment in which seedlings are germinated. Because the foamed glass article described herein is adapted for use as a thermal energy control medium, the foamed glass article can be utilized to initiate the germination process of seedlings at an early time in rural areas lacking in energy resources, such as gas or electricity.

### BRRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates a prior art pictorial drawing of a large mold in which rows of mounds of starting mixture are placed;

FIG. 2 depicts a pictorial diagram of a building having walls constructed utilizing a plurality of foamed glass articles in the shape of bricks in accordance with a preferred embodiment of the present invention;

FIG. 3 illustrates a pictorial diagram of a wall constructed utilizing a plurality of foamed glass articles for heating and/or cooling the interior of a building in accordance with a preferred embodiment of the present invention;

FIG. 4 depicts a pictorial diagram of foamed glass articles formed in the shape of blocks and/or a sheet, in accordance with a preferred embodiment of the present invention;

FIG. 5 illustrates a side-sectional view of a foamed glass article disposed within a wall or lid of a cooler in accordance with another (alternative) embodiment of the present invention;

FIG. 6 depicts a pictorial diagram of a cooler having one or more walls, including a lid and a bottom, which is formed to include a foamed glass article, in accordance with an alternative embodiment of the present invention;

FIG. 7 illustrates a pictorial diagram of a floor formed from a plurality of foamed glass articles in the shape of bricks, in accordance with an alternative embodiment of the present invention;

FIG. 8 depicts a pictorial diagram of a foamed glass article in the shape of a brick disposed within a cooler to assist in the retention of heat, in accordance with an alternative embodiment of the present invention;

FIG. 9 illustrates a pictorial diagram of a fireplace formed from a plurality of foamed glass articles, in accordance with an alternative embodiment of the present invention; and

FIG. 10 depicts a pictorial diagram of a fireproof security safe whose walls are formed from a foamed glass article, in accordance with an alternative embodiment of the present invention.

### DETAILED DESCRIPTION OF THE INVENTION

The particular values and configurations discussed in these non-limiting examples can be varied and are cited merely to illustrate embodiments of the present invention and are not intended to limit the scope of the invention.

The present inventor has discovered that foamed glass article made with at least one foaming agent can provide a universal product for energy and thermal control. Such a foaming agent may include a non-carbon/sulfate based foaming agent or simply non-sulfur based foaming agent. The foaming agent can be selected from a group of foaming agents including, but not limited to, calcium carbonate, magnesium carbonate, sodium carbonate, strontium carbonate, lithium carbonate, barium carbonate, urea, water and mixtures thereof. A block, brick, sheet, cube or other media formed from the foamed glass article described herein for use in heating and cooling applications can be referred to as a “thermal block” or a “hot cold block.” The foamed glass article described herein can also be formed from a mixture comprising glass and at least one foaming agent. The glass can powdered waste glass, recycled glass and/or virgin glass. The foamed glass article can be formed in a variety of shapes, including but not limited to the shape of a cube, a block, sheet or disk.

The present inventor has discovered that the foamed glass article described herein can be adapted for use as a thermal energy control medium, in accordance with preferred or alternative embodiments of the present invention. Note that as utilized herein, the term “thermal energy” generally refers to the control of hot, warm, cool and cold conditions, and the kinetic energy of a substance's atoms. The faster the atoms are moving, the hotter the object. Similarly, the slower the atoms are moving, the slower the object. Thermal Energy is thus the energy of motion of molecules, atoms, or ions. Thermal energy can also be referred to as heat energy, i.e., energy that causes a change in the temperature. The objective for a system focused on controlling “heat” energy can be to promote and or prevent the actually heating of an environment, depending on the application. Heat is the energy transferred from something of higher temperature to something of lower temperature. Examples of how thermal energy is used include insulation, refrigerators, air conditioners, the sun, and solar energy. Thus, a thermal control medium can be utilized for insulation, for heating or cooling a building, for storing thermal energy, and so forth.

The foamed glass article described herein is non-toxic, long lasting, and does not generate fine air-borne dust. The foamed glass product will work wet or under water without any loss of performance. The foamed glass product has a far different cellular structure than does so-called black foamed glass, which is made with a carbon/sulfate-based foaming agent. In particular, in contrast to the closed and regular cellular structure of black foamed glass, which encloses noxious gas, the preferred foamed glass can first be formed, for example, by expanding and escaping carbon dioxide gas, rather than sulfur dioxide and/or hydrogen sulfide gas. Furthermore, the cell structure of the foamed glass product described herein can be open, interconnected, and irregular, allowing ambient atmospheric gasses to penetrate the cells.

A distinct and surprising advantage of the preferred foamed glass used in accordance with the present invention is that it can be considered as an extremely economical product. This is particularly surprising and unexpected due to the experience in the past with black foamed glass, which is generally very expensive to produce. The present invention provides for the use of a far less expensive glass, especially when waste glass is used, which at the same time has a significant positive environmental impact, especially since the market for waste glass is very limited, being almost nonexistent for mixed color waste glass; thus, presently a large percentage of waste glass ends up in landfills.

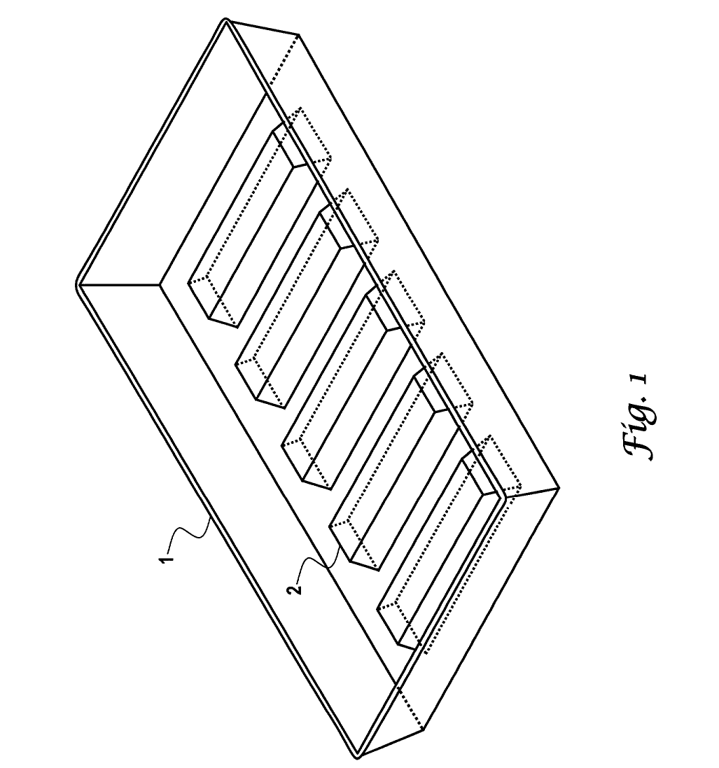

Prior to providing specific examples, the following is a more general discussion concerning production of foamed glass articles as described herein. As indicated previously, powdered virgin glass or recycled waste glass can be mixed with finely ground non-carbon/sulfate based foaming agent typically in the average range of about 80 to minus (i.e. any particles smaller than this will pass through) 325 mesh. Additional filler material (e.g., sand) can also be added to the starting mixture to vary or enhance the porous characteristic of the final product. The resulting dry mixture can be placed into a mold, such as the mold 1 of FIG. 1.

FIG. 1 illustrates a prior art pictorial drawing of a large mold in which rows of mounds of starting mixture are placed. The mixture can be expediently placed into the mold 1 in the form of several rows 2 of the mixture. These mounds or piles of mixture typically have a natural angle of repose of about 15 to 50 degrees. Even greater angles to the horizontal can be achieved by compressing the dry mixture. Depositing the mixture into shaped mounds, with or without compacting, and in the form of discrete piles or rows, helps to eliminate the folds and voids that typically appear when mixtures of this type are foamed as flattened beds of powder.

The mold 1 can be made of steel, ceramic, or ceramic fiber. The mold can be provided in the shape of a frustum in order to facilitate easy release of the final foamed glass product. In addition, the internal surfaces of the mold can be coated with a soft refractory release agent to further facilitate separation of the foam glass product from the mold.

One or more molds with the mixture therein can be placed into a furnace for either a batch or continuous foaming process. The mixture is then heated in order to sinter and foam the mixture and thereby produce the foamed glass product having a desired density, pore size and hardness. As the powdered mixture is heated to above the softening point of glass, approximately 1050° F., the mixture begins to sinter. The division of the powdered mixture into rows or mounds allows the glass to absorb heat more rapidly and to therefore foam faster by reducing the ability of the foaming glass to insulate itself. At approximately 1058° F., the calcium carbonate, if calcium carbonate has been used as the foaming agent, begins to react with some of the silicon dioxide in the glass to produce carbon dioxide gas. Carbon dioxide is also formed by any remaining calcium carbonate once the mixture reaches 1274° F., above which calcium carbonate breaks down into calcium oxide and carbon dioxide gas. The carbon dioxide is primarily responsible for the formation of cells and pores in the softened glass mass as the carbon dioxide expands. The mixture in the mold is held for a period of time at a peak foaming temperature of, for example, between 1274-1700° F., or even higher, depending on the properties that are desired. By adjusting the process temperatures and times, the density and hardness as well as other properties can be closely controlled.

As the furnace reaches foaming temperatures, each mass of foaming glass, originating from one of the discrete rows or mounds, foams until it comes into contact and fuses with its neighbors. The fused mass of foaming glass then expands to conform to the shape of the walls of the mold, filling all of the corners. The shapes and sizes of the initial mounds of mixture are very important and are determined with the anticipation that the foaming mixture exactly fills the mold. After the glass is foamed to the desired density and pore structure, the temperature of the furnace is rapidly reduced to halt foaming of the glass. When the exterior of the foamed glass in the mold has rigidified sufficiently, the mass of foamed glass cooled in the mold or can be removed from the mold and placed into a lehr for annealing. The temperature of the lehr is slowly lowered from the softening temperature of the glass to ambient temperature to anneal the block of foamed glass. Once cooled, any skin or crust can be cut off of the foamed glass product, and the product can be cut into a variety of desired shapes.

The following examples illustrate the wide variety of compositions and applications for the inventive foamed glass articles.

### EXAMPLE 1

To produce a foamed glass article in the shape of a block for use as a thermal energy control medium, 13.68 g (2.4%) calcium carbonate, minus 200 mesh, 442.32 g (77.6%) recycled float glass ground to minus 140 mesh, and 114 g (20%) filler material (e.g., sand), 60 to 100 mesh, can be mixed thoroughly together. The resulting mixture is then placed into a stainless steel mold having inside dimensions of 4¼ inches×4 inches×8¼ inches. It should be appreciated, however, that mold of carrying dimensions can be used depending on the desired shape or size of the media and its intended application. It should be appreciated by those skilled in the art that the examples contained herein are provided for exemplary methods and should not be taken as a limitation to the present invention.

The mold can be covered with an approximately ½-inch stainless steel plate. The mold with the mixture therein can be fired to 1250° F. to sinter for 60 minutes. The temperature can then be raised to 1450° F. to foam for 30 minutes. The foamed glass in the mold can be annealed by cooling slowly to room temperature over 120 minutes. The cooled block of foamed glass can be removed from the mold, and the outer layer of crust can be removed with a band saw to better expose the porous cells of the foamed glass article shaped as a block. The resulting block using the mold of the present example can have a density of 13.9 pounds per cubic foot and a pore size distribution ranging from about 0.5 to 2 mm. A block resulting from the mold of the present example can possess final dimensions of 4 inches×3.75 inches×8 inches (it is contemplated that grill cleaning blocks can range in size from 1½ inches×3¾ inches×4 inches to 2½ inches×3½ inches×6 inches to 4 inches×4 inches×8 inches). The resulting block will generally possess no odor, can be white to light gray in color, and generally possesses open, interconnected cells.

### EXAMPLE 2

A block having no filler material or embedded abrasives can be formed by a procedure similar to that of Example 1 by utilizing 17.1 g (3%) calcium carbonate, minus 200 mesh, and 552.9 g (97%) recycled container glass, minus 325 mesh. The foaming temperature can be 1400° F. for 45 minutes. The resulting density can be 7.2 pounds per cubic foot, with the resulting material having a pore size distribution ranging from about 1 to 3 mm.

### EXAMPLE 3

To prepare a foamed glass article in the shape of a block for use as a thermal energy control medium, a procedure similar to that of Example 1 can be utilized by mixing together 564.3 g (98.5%) recycled container glass, minus 325 mesh, and 5.7 g (1.5%) calcium carbonate, minus 200 mesh. The foaming temperature can be 1360° F. for 60 minutes. The resulting density can be 17.6 pounds per cubic foot, with a pore size distribution ranging from about 0.05 to 0.2 mm. The resulting block may be pure white in color due to the use of clear container glass. The resulting block can also be cut into smaller blocks of a size suitable for particular heating and/or cooling applications, and may posses final dimensions of 2 inches×2 inches×4 inches (in this case, it is contemplated that such blocks can range in size from 1 inch×1½ inches×6 inches to 2 inches×2½ inches×4 inches to 3 inches×4 inches×1½ inches).

### EXAMPLE 4

Another block for use as a thermal energy control medium can be prepared in a procedure similar to that of Example 1 by mixing together 569.4 g (99.9%) recycled container glass, minus 325 mesh, and 0.6 g (0.1%) calcium carbonate, minus 325 mesh. The foaming temperature can be 1425° for 25 minutes. The density of the resulting material can be 15.3 pounds per cubic foot, with a pore size distribution ranging from approximately 0.01 to 0.1 mm. Again, the resulting block can be cut into smaller blocks.

### EXAMPLE 4A

To produce a further block for use as a thermal energy control medium, 44 g (2%) calcium carbonate minus 200 mesh, 5.5 g (0.025%) sodium carbonate minus 200 mesh, 5.5 g (0.025%) magnesium carbonate minus 200 mesh, 2.15 kg (97.95%) recycled float glass minus 200 mesh can be mixed thoroughly together. The resulting mixture can be placed onto a ceramic mold having inside dimensions of 18 inches×10½ inches×6 inches. The mold can be covered with a ceramic lid ⅝ inches thick. The temperature can then be raised to 1250° F. to sinter for 75 minutes, the temperature was then raised to 1320° F. to foam for 40 minutes. The foamed glass in the mold can be annealed by cooling slowly to room temperature over 120 minutes. The resulting block may have a thickness of 3 inches. The cooled block of foamed glass can be removed from the mold, and the outer layer of crust can be removed with a band saw to expose the abrasive cells. The resulting block may have a density of approximately 14.9 pounds per cubic foot and a pore size ranging from about 0.5 to 1.5 mm. The resulting cut block may possess final dimensions of 2 inches×2 inches×4 inches (it is contemplated that such blocks can range in size from 1 inch×1½ inches×6 inches to 2 inches×2½ inches×4 inches to 2 inches×3 inches×4 inches).

### EXAMPLE 5

Another block for use as a thermal energy control medium can be produced in a procedure similar to that of Example 1 by mixing together 564.3 g (99%) recycled container glass, but using minus 60 mesh and 5.7 g (1%) calcium carbonate, minus 200 mesh. The foaming temperature can be 1500° F. for 20 minutes. The resulting material can possess a density of 24.3 pounds per cubic foot and a pore size distribution ranging from about 0.1 to 0.5 mm. The resulting block can be cut into convenient-to-hold blocks having final dimensions of 4 inches×3.75 inches×2 inches (it is contemplated that such blocks can have a size ranging from 4 inches×4½ inches×1½ inches to 2½ inches×3½ inches×6 inches to 3 inches×2 inches×8 inches). The color of the resulting block may be pale yellow to tan due to the use of amber container glass (it should be noted that any container glass or plate glass is potentially suitable for this purpose).

### EXAMPLE 6

A fine pore block can be produced in a procedure similar to that of Example 1 by mixing together 552.9 g (97%) recycled float glass, minus 140 mesh, and 17.1 g (3%) calcium carbonate, minus 200 mesh. The foaming temperature can be 1360° F. for approximately 60 minutes. The resulting material may possess a density of approximately 19.8 pounds per cubic foot, and a pore size distribution ranging from approximately 0.05 to 0.2 mm. Again, the resulting block can be cut into conveniently sized blocks, disks or other shapes as necessary for its effective heating and/or cooling deployment.

### EXAMPLE 7

A medium pore block for use as a thermal energy control medium cab be produced in a procedure similar to that of Example 1 by mixing together 552.9 g (97%) recycled float glass, minus 200 mesh, and 17.1 g (3%) calcium carbonate, minus 200 mesh. The foaming temperature can be 1500° for 20 minutes. The resulting material may possess a density of 11.2 pounds per cubic foot, and a pore size distribution ranging from approximately 0.5 to 1.5 mm. The resulting block can be cut into blocks having final dimensions of approximately 4 inches×3.75 inches×2 inches.

### EXAMPLE 8

Another medium pore block for use as a thermal energy control medium can be produced by mixing together 535.8 g (94%) recycled float glass, minus 140 mesh, and 34.2 g (6%) calcium carbonate, minus 200 mesh. The foaming temperature can be 1500° F. for 20 minutes. The resulting material may have a density of approximately 15.6 pounds per cubic foot, and a pore size distribution ranging from approximately 0.5 to 1.0 mm. Again, the resulting block can be cut into blocks of varying shapes and sizes.

### EXAMPLE 9

Another block for use as a thermal energy control medium can be prepared in a procedure similar to that of Example 1 by mixing together 13.68 g (2.4%) calcium carbonate, minus 200 mesh, 442.32 (77.6%) recycled container glass ground to minus 60 mesh, and 114 g (20%) sand, 60 to 100 mesh. The foaming temperature can be 1500° F. for approximately 20 minutes. The resulting material may have a density of approximately 27.8 pounds per cubic foot, and a pore size distribution ranging from approximately 1 to 3 mm. The resulting block can again be cut into smaller blocks or disks of a size convenient to deploy in, for example, a cooler or ice chest. The resulting block may be pale yellow to tan in color due to the use of amber container glass.

### EXAMPLE 10

Another porous block for use as a thermal energy control medium can be produced in a procedure similar to that of Example 1 by mixing together 57.0 g (10%) calcium carbonate, minus 200 mesh, and 513 (90%) recycled container glass ground to minus 325 mesh. The foaming temperature can be 1600° F. for 15 minutes. The resulting material may have a density of approximately 17.2 pounds per cubic foot, and a pore size distribution ranging from about 2 to 4 mm. The resulting block can again be cut into blocks of a size convenient to hold by hand.

### EXAMPLE 11

In order to produce a sheet for use as a thermal energy control medium, 15.81 kg (93%) of minus 140 mesh recycled float glass can be mixed together with 1.19 kg (7%) of minus 200 mesh calcium carbonate. The mixture can be placed in a mold having a dimension of at least 22 inches×at least 46 inches×at least 5 inches in depth, and the mold can be covered with a stainless steel lid. The mold and mixture can be sintered at 1250° F. for 60 minutes, whereupon the temperature can be raised to foam at 1500° F. for 40 minutes. The temperature can then be lowered slowly to room temperature over 360 minutes. The resulting mass of foamed glass may have dimensions of approximately 22 inches×46 inches×6 inches (the extra inch in width is due to the lifting of the lid by the expanding foam). The resulting material may possess a density of approximately 19.5 pounds per cubic foot, and a pore size distribution ranging from approximately 1 to 2.4 mm. The resulting mass of foamed glass can be sliced/cut into multiple sheets, having at least a 1-2 inch thickness. Cutting can be achieved using and industrial band saw.

### EXAMPLE 12

Another sheet for use as a thermal energy control medium uses can be produced in a procedure similar to that of Example 11 by mixing together 16.32 kg (96%) of minus 325 mesh recycled container glass and 0.68 kg (4%) of minus 200 mesh calcium carbonate. The foaming temperature can be 1450° F. for 60 minutes. The resulting material may have a density of approximately 14.8 pounds per cubic foot and a pore size distribution ranging from about 0.5 to 1.5 mm. The resulting mass of foamed glass can again be cut into about three two-inch thick sheets.

### EXAMPLE 13

A block for use as a thermal energy control medium can also be formed by a procedure similar to that of Example 11 by mixing together 16.49 kg (97%) of minus 140 mesh float glass and 0.51 kg (3%) of minus 200 mesh calcium carbonate. The foaming temperature can be 1500° F. for 40 minutes. The resulting foamed glass material may have a density of approximately 11.9 pounds per cubic foot and a pore size distribution of about 1.2 to 2.8 mm. The resulting mass of foamed glass can be cut into multiple blocks, which are then cut into blocks having dimensions of approximately 4 inches×4 inches×2.5 inches (it is contemplated that such blocks could range in size from 1½ inches×4¼ inches×4½ inches to 2 inches×3¾ inches×71/4 inches).

### EXAMPLE 14

Another block for use as a thermal energy control medium can be produced in a procedure similar to that of Example 11 by mixing together 16.49 kg (97%) of minus 60 mesh recycled container glass and 0.51 kg (3%) of minus 200 mesh calcium carbonate. The foaming temperature can be 1500° F. for 40 minutes. The resulting material may be similar to that of Example 13 except that it may possess a density of approximately 18.3 pounds per cubic foot and a pore size distribution ranging from about 2 to 4 mm. Such blocks can be prepared in a manner similar to that described in Example 13, with the blocks having a pale yellow to tan color due to the use of amber container glass.

### EXAMPLE 15

To produce another type of block for use as a thermal energy control medium, a procedure similar to that of Example 1 can be utilized by thoroughly mixing together 541.5 g (95%) recycled float glass, minus 200 mesh, and 28.5 g (5%) of calcium carbonate, minus 200 mesh. The foaming temperature can be 1400° F. for 45 minutes. The resulting material may have a density of 16.6 pounds per cubic foot, and a pore size distribution ranging from about 0.05 to 0.2 mm. The resulting block can be cut into smaller blocks of a suitable sizes, and may possess final dimensions of approximately 4 inches×4 inches×3 inches (it is contemplated that blocks can range in size from 3½ inches×4 inches×3 inches to 4 inches 4 inches×1½ inches to 4 inches×4 inches×8 inches).

### EXAMPLE 16

Another block can be produced in a procedure similar to that of Example 1 by mixing together 552.9 g (97%) recycled container glass, minus 325 mesh, and 17.1 g (3%) of magnesium carbonate, minus 200 mesh. The foaming temperature can be 1400° F. for 45 minutes. The resulting material may have a density of 28.6 pounds per cubic foot, and a pore size distribution ranging from 0.01 to 0.2 mm. The resulting block can again be cut into smaller blocks of 4 inches×4 inches×3 inches.

### EXAMPLE 17

Additionally a block can be produced by a procedure similar to that of Example 1 by mixing together 456 g (80%) recycled container glass, minus 325 mesh, and 114 g (20%) of calcium carbonate, minus 325 mesh. The foaming temperature can be 1700° F. for 15 minutes. The resulting material may have a density of 42.6 pounds per cubic foot and a pore size distribution ranging from approximately 0.01 to 0.1 mm.

### EXAMPLE 18

The following example provides some additional details that can be considered in the molding of the foamable mixture. To produce a block of foamed glass material for use in for use as a thermal energy control medium, for example, 12 kg of a foamable glass mixture can be prepared by thoroughly mixing together for 20 minutes in a mechanical mixer 2.4% by weight calcium carbonate powder (100% of which passes through a 200 mesh screen), 77.6% by weight recycled or virgin glass (100% of which passes through a 325 mesh screen), and 20% by weight common filler material such as for example, sand (100% of which passes through a 40 mesh screen but which does not pass through an 80 mesh screen). Note that although filler material such as sand is discussed herein, those skilled in the art can appreciate that other types of material may also be utilized in accordance with the present invention. A ¼ inch stainless steel plate having a dimension of 20 inches×26 inches can be coated with a thin slurry of talc and alumina as agents to prevent sticking. A stainless steel mold can be coated with the same slurry.

The mold can have the shape of a frustum and may be open at the base. The base dimensions can be 20 inches×26 inches, and the peak dimensions can be 19 inches×26 inches. The mold itself can be 6 inches deep. The foamable mixture can be divided into four equal portions of 3 kg each, and each portion is generally placed on the 20 inch×26 inch plate in a row such that it possesses base dimensions of 4.5 inches×16 inches. The four rows can be evenly spaced 2 inches apart. The rows, which may run parallel to the 26 inches dimension of the plate, can be spaced 1 inch away from the edge of the plate. The ends of the rows can be placed 2 inches away from the edges of the plate having the 20-inch dimensions.

Each row may have a trapezoidal cross-section the base of which is generally 4.5 inches and the top of which can be 3.5 inches, with a height of approximately 3 inches. Each portion can be compacted into the above shape, and the bulk density of the powder after being compacted may be 72 pounds per cubic foot. The frustum shaped lid can be lowered onto the plate that supported the mounds of foamable mixture, whereupon the entire assembly can be placed into a furnace. The furnace can be rapidly heated to 1250° F. and can be held there for one hour to allow the foamable mixture to sinter and absorb heat evenly.

The temperature can then be increased to 1500° F. and held there for 60 minutes. The mounds of powder will then foam, fuse, and fill the mold during this process. The temperature can be then rapidly lowered to 1050° F. and is generally held there for 15 minutes to halt the foaming process and to solidify the outside skin of the mass of foamed glass. The frustum shaped portion of the mold then be removed from the mass of solidified foamed glass. The block of foamed glass can then be placed in an annealing lehr, which slowly cools the foamed glass from 1050° F. to ambient temperature. The finished and cooled block of foamed glass can then be planed and trimmed to remove the glassy skin and traces of release agent. The finished cut block of foamed glass generally can have dimensions of 18 inches×24 inches×4 inches, a density of 19.3 pounds per cubic foot, and a pore size distribution ranging from about 2.0 to 5.0 mm. The finished block of foamed glass can then be cut into a variety of regular shapes for utilization in for use as a thermal energy control medium.

Although carious quantities, temperatures, ingredients and mold sizes have been described in Examples 1-18, it should be appreciated by those skilled in the art that modifications can be made to achieve a foamed glass article of different consistency and dimensions that can be uniquely utilized as will be taught in the following systems, apparatuses and methods of use.

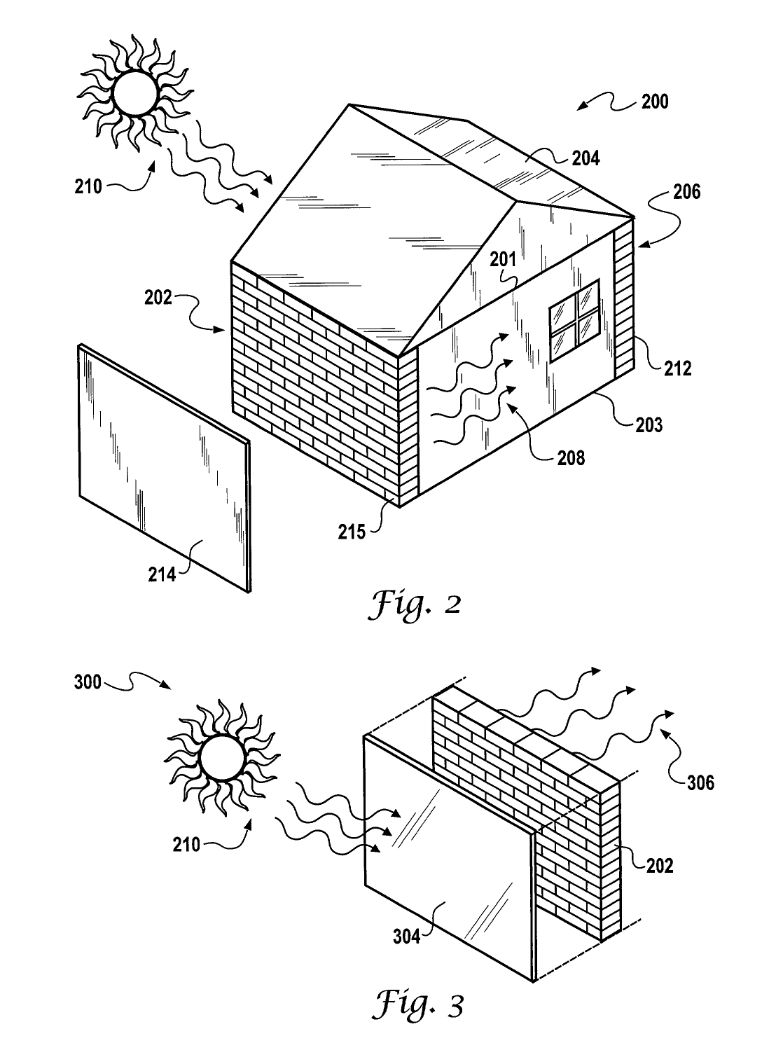

FIG. 2 depicts a pictorial diagram 200 of a building 204 having walls 202 and 206 constructed utilizing a plurality of foamed glass articles in the shape of bricks in accordance with a preferred embodiment of the present invention. Arrows 208 generally illustrates the flow of heat provided from the sun 210 and emanating from wall 202 into building 204. Wall 202 can be formed from a plurality of bricks 210. Wall 206 can also be formed from a plurality of bricks 212. Each brick can be formed from a foamed glass article, such as the foamed glass articles described herein. Each foamed glass article can thus be formed in the shape of a brick, wherein each foamed glass article brick functions as a thermal energy control medium. Energy from the sun 210 is captured by each foamed glass article and transmitted into the interior of building 204. It should be appreciated that the foamed glass could be provided in the form of sheets (e.g., like drywall, wallboard or sheetrock) for walls 210 and 212, and the present embodiment is just one way of carrying out the invention.

To further enhance the thermal energy control features of such bricks, each brick may be painted a dark color, such as black, to promote energy absorption thereof. Various fans and heat delivery systems can be associated with such foamed glass articles to assist in the delivery of heat to the interior of building 200. It can be appreciated by those skilled in the art that in the summer time, one or more exterior covers 214 (e.g., shades, light paint color, etc.) can be placed over walls 202 and 216 to respectively prevent the absorption of thermal energy by the foamed glass articles 210 and 212. In such a summertime situation or in hot weather environments, an air conditioning unit operating within building 204 can provide cool air internally, such that walls 202 and 206 prevent cool air and thus cooler thermal energy from escaping from building 204. Although only two walls 204 and 206 are illustrated in FIG. 2, it can be appreciated that all four walls, including the ceiling 201 and floor 203 of building 204, can similarly be configured with foamed glass thermal control media as described herein to provide heating and/or cooling features to building 204. As utilized herein, the term “wall” should be read to not only refer to the vertical structures of a building or container, but also to structures, such as a ceiling, roof or floor of a building or container.

FIG. 3 illustrates a pictorial diagram 300 of the wall 202 of FIG. 2 constructed utilizing a plurality of foamed glass brick-like articles for heating and/or cooling the interior of a building, such as building 204, in accordance with a preferred embodiment of the present invention. Note that in FIGS. 2 and 3 like or analogous parts are indicated by identical reference numerals. Thus, wall 202 of FIG. 3 is analogous to wall 202 of FIG. 2, which in turn is similar to wall 206. Sun 210 can provide thermal energy through a window 304, which can be placed in front of wall 202. Arrows 306 indicate heat flow into a region within a building or area, such as building 204 of FIG. 2. Window 304 can be configured as a clear window or as a window that is tinted or colored black, depending on desired thermal energy applications.

FIG. 4 depicts a pictorial diagram 400 of foamed glass articles formed in the shape of blocks 402 and/or a sheet 404, in accordance with a preferred embodiment of the present invention. Blocks 402 can be combined to form, for example, a wall or floor of a building. Sheet 404 illustrates a foamed glass object of the type described herein, which can be adapted for a variety of thermal energy control purposes. For example, a sheet such as sheet 404 can be divided into a plurality of tiles or can function as siding for a building. Sheet 404 can be utilized, for example, in place of dry wall in construction. Like drywall, particleboard and siding materials, the thickness and width of sheet 404 can vary, depending on the desired application.

The foam glass article described herein can be adapted for use with passive solar energy and conventional heating and/or cooling systems. Many different types of heated and cooled building structures are known in the art. The common elements for the utilization of active solar energy include a solar heat collector, a heat storage unit, a heat transfer medium, and means for circulating the heat transfer medium between the collector and storage unit. Such systems generally include sophisticated control systems for operating the movement of the heat transfer medium and a control of the unit in relation to the weather conditions, the heat demand of the structure and so forth. When the unit also includes an air conditioner, such elements as a compressor, evaporator, cooling coils, air circulator and the like can be utilized in addition to other elements. Conventional HVAC systems are well known in the art.

An example of a building with passive solar energy conditioning, which may be modified in accordance with the present invention described herein is disclosed in U.S. Pat. No. 4,119,084, entitled “Building with Passive Solar Energy Conditioning,” which issued to Robert E. Eckels on Oct. 10, 1978, and is disclosed herein by reference. Eckels describes a structure or building with a solar energy collecting system in an upright wall, arranged to face the sun, which includes a heat storage unit located adjacent the wall for storing heat absorbed by the collecting system in sunlight, and for releasing the heat to the interior of the building in the absence of sunlight during those seasons requiring additional heat for the building, and a solar heat collector system for the building arranged to provide a chimney effect for circulating air through the structure during seasons when heating of the structure is not desired (e.g., summer time). The walls of such a structure can be constructed with bricks formed from the foamed glass article (i.e., thermal energy control medium) described herein. The roof of the structure illustrated in U.S. Pat. No. 4,119,084 can also be modified to integrate the foamed glass article described herein, in the form of, for example, a plurality of foamed glass articles in the shapes of blocks, bricks, tiles, and/or sheets. Such blocks, bricks, tiles, and/or sheets thus functions a thermal energy control medium. Those skilled in the art can appreciate that this type of passive solar energy system is incorporated herein by reference for general illustrative and edification purposes only and does not amount to a limiting feature of the present invention.

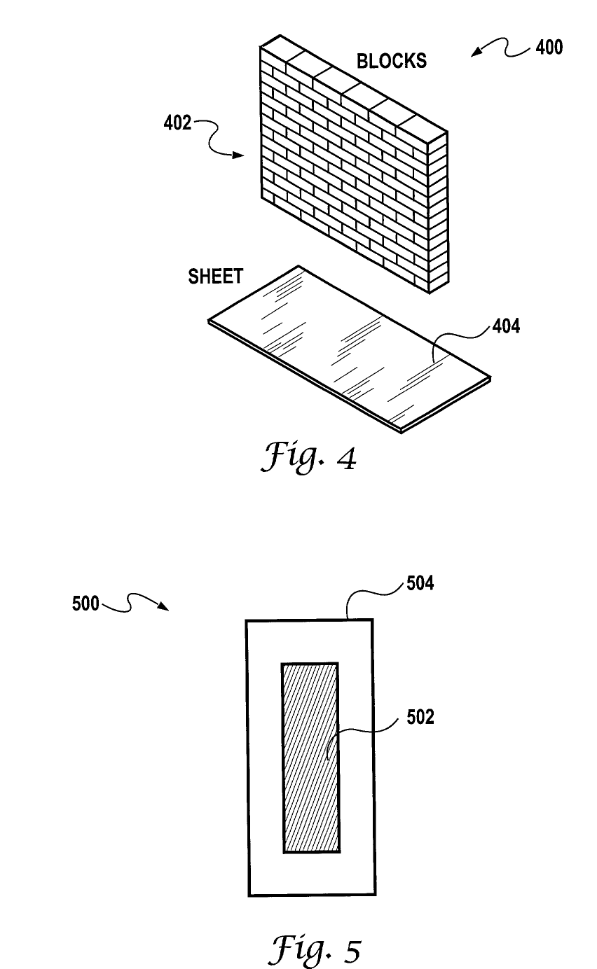

FIG. 5 illustrates a side-sectional view 500 of a foamed glass article 502 disposed within a wall 504 (or lid) of a container in accordance with an alternative embodiment of the present invention. For purposes of example, the container of FIG. 5 is illustrated to appear as a conventional recreational cooler (e.g., ice chest). Such a cooler can be configured, for example, as an ice chest or cooling container, such as a refrigerator. The term “cooler” as utilized herein thus generally refers to cooling containers such as refrigerators or ice chests. Some coolers are configured as boxshaped containers within which ice is deposited. Drinks, food articles and other items requiring cooling can then be placed into the ice chest along with the ice. A lid covers the ice chest, which is usually portably and easily transported and handled by a single individual. Such ice chests are popular at picnics, outdoor barbecues, and so forth. The walls of such ice chests, which are generally made of plastic or metal materials, can thus be modified to incorporate a foamed glass article, such that the foamed glass article functions as a thermal energy control medium, which assists in keeping the ice chest cold, cool, warm or hot.

Other types of containers can be structured as ice cooled beverage dispensers, for example, for cooling soft drinks and other beverages, and are well known in the art. Vending machines, refrigerators and freezers are examples of such containers. These beverage dispensers are known and used extensively in restaurants, bars, amusement parks, concession stands, movie theatres and the like. The ice cooled beverage dispensers typically utilize an ice chest including a cast aluminum cold plate to chill carbonated water and flavoring syrups before mixing and dispensing these liquids in a finished soft drink. Such dispensers generally include a source of carbonated water, a source of flavoring syrup, a cold plate to cool the carbonated water and syrup and dispensing valves to mix the carbonated water and syrup prior to dispensing the mixed beverage into a glass or cup. The walls of these types of ice cooled beverage dispensers can thus be configured to incorporate one or more foamed glass articles for use as thermal energy control medium, which assists in keeping the ice cooled beverage dispenser cool.

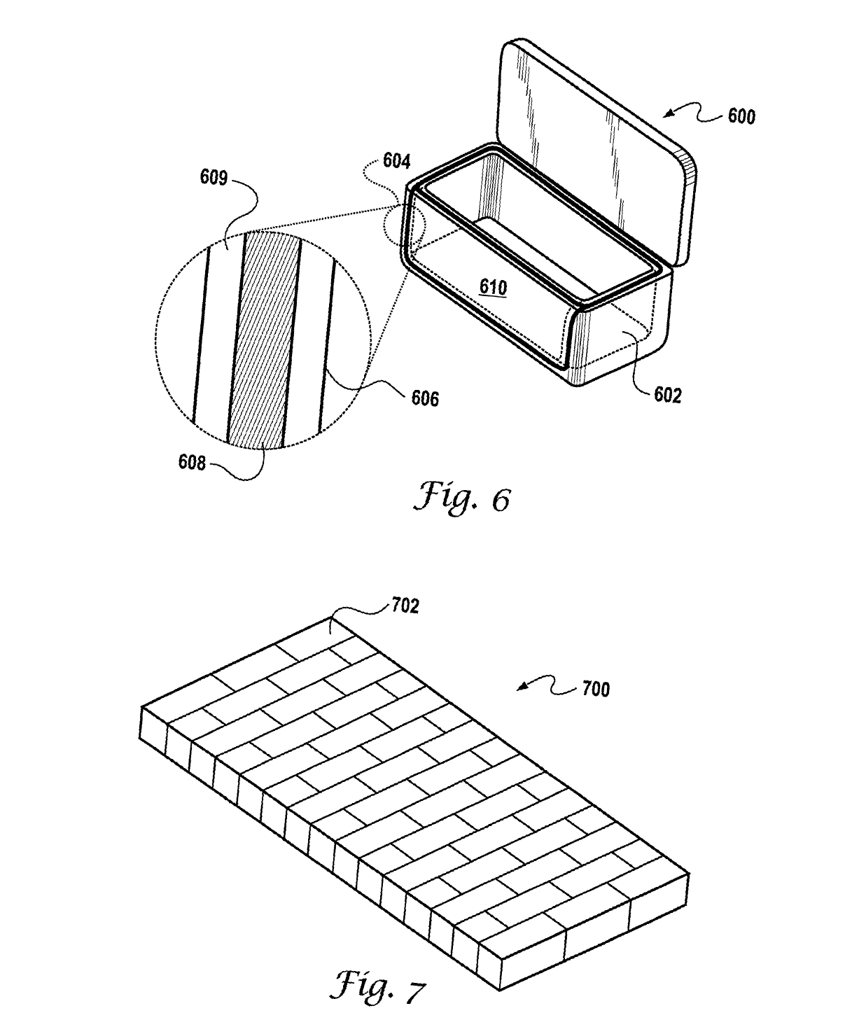

FIG. 6 depicts a pictorial diagram 600 of a container 602 having one or more walls, including a lid, which is formed to include a foamed glass article, in accordance with an alternative embodiment of the present invention. Container 602 can be configured as a portable cooler. A cutaway view of the walls (including the bottom) of the container 602 is depicted at dashed circle 604, an exploded view of which provides detail. A wall 606 surrounds a gap 609 within which a foamed glass article 608 is located. Wall 606 may be configured to include a metal, such as aluminum, or plastic, which surrounds and encases foamed glass article 608. Foamed glass article 608 thus functions as a thermal energy control medium, which assists in maintaining a desired thermal condition (hot, warm, cool or cold) within the interior 610 of container 602. It should be appreciated that us of foamed glass articles 608 within container 602 is just one example of a system for providing thermal control to an environment 610. Containers that can also benefit from the teachings of FIGS. 5 and 6 can be provided in different forms, portable or fixed, such as kitchen appliances. For example, electric and/or gas refrigerators, freezers, ovens and food warmers require thermal control and are commonly found within a kitchen environment.

FIG. 7 illustrates a pictorial diagram 700 of a floor 702 formed from a plurality of foamed glass articles in the shape of bricks or blocks, in accordance with an alternative embodiment of the present invention. Floor 702 can be utilized for example, in constructing a floor of building 204 illustrated in FIG. 2. Situations may arise, for example, when it is necessary to prevent heat from escaping from the floor of a building such as a house or office complex, particularly in colder environments. Each brick of floor 702 is formed from a foamed glass article. Each foamed glass article functions as a thermal energy control medium, which assists in preventing heat from escaping through floor 702. Such a floor 702 can find particularly useful applications in multi-floor buildings.

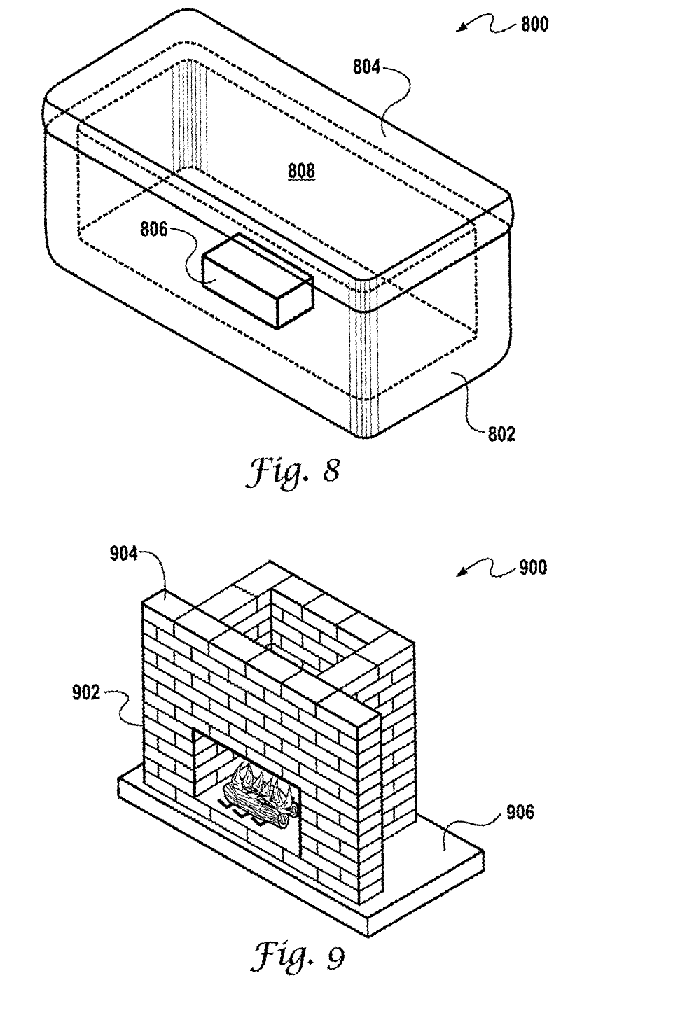

FIG. 8 depicts a pictorial diagram of a foamed glass article 806 in the shape of a brick disposed within a container 804 to assist in the retention of heat, in accordance with an alternative embodiment of the present invention. Container 804 includes a plurality of walls, one of which is shown as wall 802. Container 804 also includes a lid 804. Foamed glass article 806 can be soaked with water or another liquid and then frozen. One or more foamed glass articles 806 can then be placed within container 804 for cooling the container's contents.

FIG. 9 illustrates a pictorial diagram 900 of a fireplace 902 formed using a plurality of foamed glass articles 904, in accordance with an alternative embodiment of the present invention. Each foamed glass article 904 can be formed in the shape of a brick or block. A foundation 906 sits below fireplace 902 and provides support thereof. Each foamed glass article 904 can be configured as a brick, which functions as a thermal energy control medium. Fireplace 902 can thus be configured as a brick fireplace, well known in the art. Brick fireplaces are conventionally built entirely from brick, which is used to form the firebox and the throat of the fireplace. The throat, or smoke chamber, as it is sometimes known, usually tapers inwardly and upwardly form the firebox to the relatively small tubular clay flue liner extending through the chimney.

Fireplaces come in all sizes, but generally, the cross-sectional dimensions of the firebox is always larger than those dimensions of the flue of a fireplace. One function of the throat in a fireplace is to gradually reduce the cross sectional dimensions of the area between the firebox and the flue of the fireplace. An example of a fireplace, which can be modified to include foamed glass articles as interior and/or exterior walls for a brick fireplace, is disclosed in U.S. Pat. No. 5,168,862, entitled “Fireplace Throat and Process,” which issued to Donald R. McGee on Dec. 8, 1992 and which is incorporated herein by reference. Those skilled in the art can appreciate that this type of device is incorporated herein by reference for general illustrative and edification purposes only and does not amount to a limiting feature of the present invention.

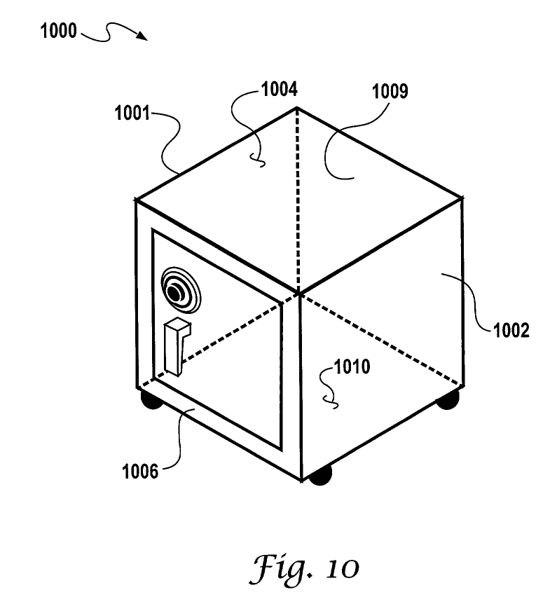

FIG. 10 depicts a pictorial diagram 1000 of a fireproof security safe 1001 with walls that can be formed from a foamed glass article, in accordance with an alternative embodiment of the present invention. A fireproof security safe 1001 is a type of fireproof container whose walls can generally include, but are not limited to this configuration, a right wall 1002, a top wall 1004, a left wall 1006, a back wall 1009, and a bottom wall 1010. Fireproof security safe 1001 can be utilized as a security structure for home, commercial and/or industrial applications. The use of foamed glass articles, such as described herein, for forming the walls of fireproof security safe 1001 can provide heat-insulated capabilities to fireproof security safe 1001. Security safes for storing valuable are well known in the art. The use of the foamed glass article described herein for forming fireproof walls for such devices are not known and would provide an additional benefit of securing the contents of a safe from fire or heat damage.

Based on the foregoing, it can be appreciated that the present invention discloses methods and apparatuses for the control of thermal energy utilizing a foamed glass article. A foamed glass article can be provided as a thermal energy control medium. The foamed glass article (i.e., thermal energy control medium) can be integrated into an object, such as a building, a fireplace, a floor, a container and so forth, to assist in maintaining thermal energy within the object, including an environment associated with the object.

The foamed glass article can be configured in the shape of a block, sheet, disk, brick, a plurality of cubes, and so forth. If the object is a building, one or more walls, including the roof, ceiling and/or floor, associated with the building can be formed utilizing the foamed glass article to provide passive heating and cooling for the building environment, or to provide insulation for buildings using conventional HVAC systems. If the object comprises a container, such as a cooler, medical or laboratory cooling mechanism, or kitchen appliance, it can be configured such that the walls (including the lid or door, and bottom) of the container includes a gap or area within which the foamed glass article (i.e., thermal energy control medium) is located, thereby forming a thermal barrier to assist promoting a desired temperature within the container's environment.

Additionally, the foamed glass article (i.e., thermal control medium) can be soaked with water or another liquid and then frozen. Once the foamed glass article is frozen, the foamed glass article can be placed within a container to assist in cooling. The foamed glass article can be thawed and then reused. The object can also be configured as the interior and/or exterior walls of a fireplace constructed using the foamed glass article to promote the retention of heat and fire thereof.

The object can also be a container, such as a safe, which is constructed from the foamed glass article to thereby configure the container as a fireproof container. Additionally, the object can be arranged as an agricultural environment in which seedlings are germinated. Because the foamed glass article described herein is adapted for use as a thermal energy control medium, the foamed glass article can be utilized to initiate the germination process of seedlings at an early time in rural areas lacking in energy resources, such as gas or electricity.

Note that a foamed glass article configured as a sheet in accordance with the invention described herein can be referred to herein as “sheet glass.” Sheet glass can be similar in construction to “sheet rock,” which is utilized in the construction industry. Sheet rock is typically formed from gypsum board and is sold in standard sizes, generally four feet wide by eight feet long, for example, and can be utilized for interior wall and ceiling surfaces of a building or home. Sheet rock has also been referred to in the industry as “wall board.” Wall board or sheet rock typically has a center chalk-like layer with a thickness of about ⅜ inch to ¾ inch and includes front and back surfaces made of paper-based (e.g., cardboard) material. Such surface material is important in preventing moisture from penetrating the chalk-like material or for providing a suitable pallet for the acceptance of paint. Otherwise, the chalk would absorb excessive paint. With the present invention, it should be appreciate by those skilled in the art that “sheet glass” could be constructed in a similar fashion to sheet rock for the purposes describe herein.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method for controlling thermal energy utilizing a foamed glass article, said method comprising the steps of:
providing a foamed glass article as a thermal energy control medium; and
integrating said foamed glass article into an object to assist in maintaining thermal energy within said object, including an environment associated with said object.

2. The method of claim 1 further comprising the step of:
configuring said foamed glass article in a shape of a block.

3. The method of claim 1 further comprising the step of:
configuring said foamed glass article as sheet glass.

4. The method of claim 1 further comprising the steps of:
configuring said object as a building, wherein said environment associated with said object comprises a building environment thereof; and
constructing said building, wherein at least one wall associated with said building is formed utilizing said foamed glass article to thereby provide passive heating and cooling for said building environment.

5. The method of claim 4 further comprising the step of:
constructing said building, wherein a floor associated with said building is formed utilizing said foamed glass article to thereby provide passive heating and cooling for said building environment.

6. The method of claim 1 further comprising the steps of:
configuring said object to comprise a container, wherein said environment associated with said object comprises a container environment thereof;
configuring said container to comprise container walls thereof, which surround said cooler environment, and
forming said container walls to form a gap therein within which said foamed glass article is located and surrounded by a container barrier to thereby assist in preventing thermal energy from escaping from said container environment.

7. The method of claim 1 further comprising the steps of:
wetting said foamed glass article;
thereafter freezing said foamed glass article; and
placing said foamed glass article within said object to thereby cool said object and said environment associated with said object, wherein said object comprises a cooler.

8. The method of claim 1 further comprising the step of:
configuring said object to comprise a fireplace; and
constructing walls of said fireplace with said foamed glass article, wherein said foamed glass article promotes retention of heat thereof.

9. The method of claim 1 further comprising the steps of:
configuring said object to comprise a container; and
constructing said container with said foamed glass article to thereby configure said container as a fireproof container.

10. The method of claim 1 further comprising the steps of:
configuring said object to comprise an agricultural environment in which seedlings are germinated; and
initiating a germination process of said seedlings utilizing said thermal energy control medium formed from said foamed glass article.

11. The method of claim 1 wherein said foamed glass article is formed from a starting mixture that comprises glass and at least one foaming agent.

12. The method of claim 11 wherein said at least foaming agent comprises a noncarbon/sulfate based foaming agent.

13. An apparatus for controlling thermal energy, said apparatus comprising:
a foamed glass article adapted for use as a thermal energy control medium; and
wherein said foamed glass article is integrated into an object to assist in maintaining thermal energy within said object, including an environment associated with said object.

14. The apparatus of claim 13 wherein said foamed glass article is configured in a shape of a block.

15. The apparatus of claim 13 wherein said foamed glass article is configured as sheet glass.

16. The apparatus of claim 13 wherein:
said object comprises a building, wherein said environment associated with said object comprises a building environment thereof; and
at least one wall associated with said building is formed utilizing said foamed glass article to thereby control heating and cooling for said building environment.

17. The apparatus of claim 16 wherein a floor associated with said building is formed utilizing said foamed glass article to thereby provide passive heating and cooling for said building environment.

18. The apparatus of claim 13 wherein
said object comprises a cooler, wherein said environment associated with said object comprises a cooler environment thereof;
said cooler comprises cooler walls thereof, which surround said cooler environment, and
said cooler walls are configured to form a gap therein within which said foamed glass article is located and surrounded by a cooler barrier to thereby assist in preventing thermal energy from escaping from said cooler environment.

19. The apparatus of claim 13 wherein said foamed glass article is wet and frozen and placed within said object to thereby cool said object and said environment associated with said object, such that said object comprises a cooler.

20. The apparatus of claim 13 wherein:
said object comprises a fireplace; and
said fireplace is constructed using said foamed glass article to promote retention of heat thereof.

21. The apparatus of claim 13 wherein:
said object comprises a container; and
said container comprises said foamed glass article.

22. The apparatus of claim 13 wherein:
said object comprises an agricultural environment in which seedlings are germinated; and
said thermal control medium initiates a germination process of said seedlings.

23. The apparatus of claim 13 wherein said foamed glass article is formed from a starting mixture that comprises glass and at least one foaming agent.

24. The apparatus of claim 23 wherein said at least foaming agent comprises a non-carbon/sulfate based foaming agent.

25. An apparatus for controlling thermal energy, said apparatus comprising:
a foamed glass article adapted for use a thermal energy control medium, wherein said foamed glass article is formed from a starting mixture that comprises glass and at least one foaming agent; and
wherein said foamed glass article is integrated into an object having a plurality of walls therein, such that said thermal control medium assists in maintaining thermal energy within said object, including an environment associated with said object.
